(19) United States
(12) Patent Application Publication
(10) Pub. No.: US 2005/0138366 A1
(43) Pub. Date: Jun. 23, 2005

(54) IPSec acceleration using multiple micro engines

(76) Inventors: Pan-Loong Loh, Toronto (CA); Alwyn Dos Remedios, Markham (CA); Bob S. Pabla, Woodbridge (CA); Walter Gilmore, Brampton (CA); Wajdi K. Feghali, Ottawa (CA); Robert P. Ottavi, Brookline, NH (US); Bradley Burres, Cambridge, MA (US)

Correspondence Address: FISH & RICHARDSON, PC, 12390 EL CAMINO REAL, SAN DIEGO, CA, 92130-2081, US

(21) Appl. No.: 10/742,512

(22) Filed: Dec. 19, 2003

(51) Int. Cl. H04L 9/00

(52) U.S. Cl. 713/160

(57) ABSTRACT

A network forwarding device includes at least one physical interface, a framer and a network processor having multiple processing engines arranged as: a preparation stage provided on a first microengine of a processor having plural microengines the preparation stage to prepare the packet for processing, a processing stage provided on a second microengine of the processor, the processing stage to perform at least one crypto operation on the packet and a final stage provided on a third microengine of the processor to perform validate the packet in accordance with security associations and a switch fabric.

### BACKGROUND

Mechanisms are known for providing cryptographic security services in network layers such as the Internet Protocol layer to protect traffic over public networks. One example is the IPSec protocol, a framework of open standards developed by the Internet Engineering Task Force (IETF).

IPSec provides security for transmission of sensitive information over unprotected networks such as the Internet. IPSec acts at the network layer, protecting and authenticating IP packets between participating IPSec devices (“peers”), such as routers.

The IPSec protocol provides network security services including data confidentiality where an IPSec enabled device can encrypt packets before transmitting them across a network and the packets are decrypted at the receiver device. Other services include data integrity where an IPSec receiver device authenticates packets sent by an IPSec sender to ensure that the data has not been altered during transmission and can also provide data origin authentication services. Another service is an anti-replay service that allows the IPSec receiver to detect and reject replayed packets.

### DESCRIPTION OF DRAWINGS

FIG. 1 is a block diagram of a network forwarding device using a network processor.

FIG. 2 is a block diagram of an arrangement of microengines for processing IPSec packets.

FIGS. 3-6 are flow charts depicting details of IPSec decryption processing.

FIGS. 7-8 are flow charts of depicting details of IPSec encryption processing.

### DETAILED DESCRIPTION

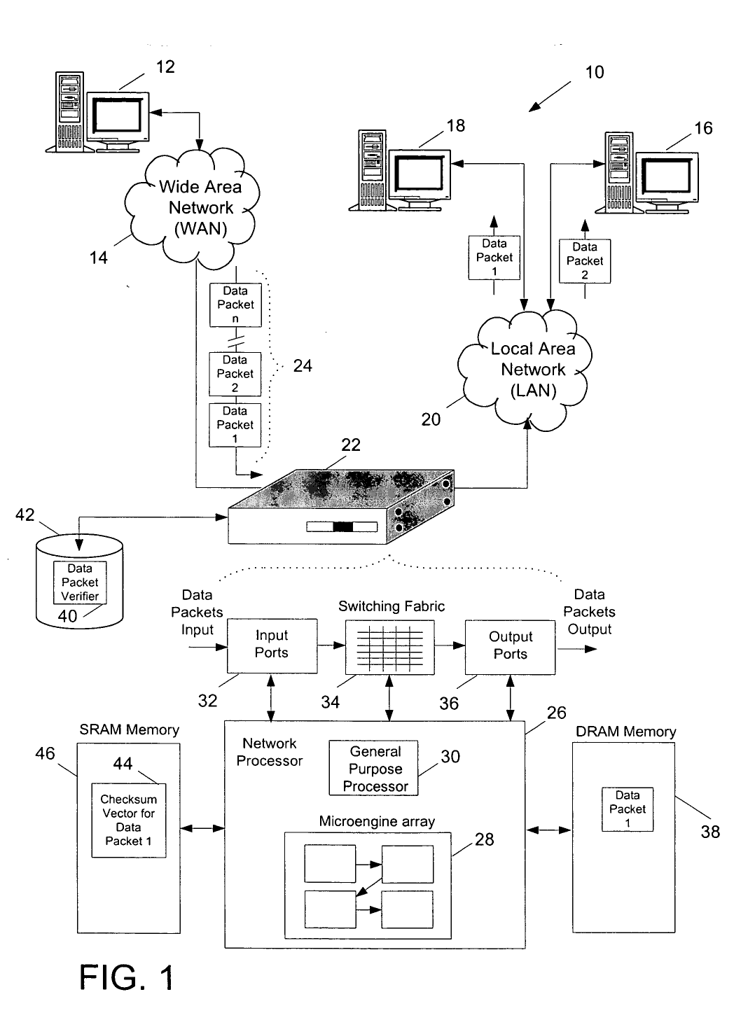

Referring to FIG. 1, a system 10 for transmitting data packets from a computer system 12 through a wide area network (WAN) 14 to other computer systems 16, 18 through a local area network (LAN) 20 includes a router 22 that collects a stream of “n” data packets 24 and routes the packets through the LAN 20 for delivery to the appropriate destination computer system 16 or computer system 18. In this example, after verification, data packet 1 is transmitted for delivery at computer system 18 and data packet 2 is transmitted for delivery at computer system 16.

The router 22 includes a network processor 26 that processes the data packet stream 24 with an array of, e.g., four, six or twelve programmable multithreaded microengines 28. Each microengine executes instructions that are associated with an instruction set (e.g., a reduced instruction set computer (RISC) architecture) used by the array of microengines 28 included in the network processor 26. Since the instruction set is designed for specific use by the array of microengines 28, instructions are processed relatively quickly compared to the number clock cycles typically needed to execute instructions associated with a general-purpose processor.

Each one of the microengines included in the array of microengines 28 has a relatively simple architecture and quickly executes relatively routine processes (e.g., data packet verifying, data packet classifying, data packet forwarding, etc.) while leaving more complicated processing (e.g., look-up table maintenance) to other processing units such as a general-purpose processor 30 (e.g., a StrongArm processor of ARM Limited, United Kingdom) also included in the network processor 26.

Typically the data packets are received by the router 22 on one or more input ports 32 that provide a physical link to the WAN 14 and are in communication with the network processor 26 that controls the entering of the incoming data packets. The network processor 26 also communicates with a switching fabric 34 that interconnects the input ports 32 and output ports 36. The output ports 36, which are also in communication with the network processor 26, are used for scheduling transmission of the data packets to the LAN 20 for reception at the appropriate computer system 16 or 18. Typically, incoming data packets are entered into a dynamic random access memory (DRAM) 38 in communication with the network processor 26 so that they are accessible by the microengine array 28 for determining the destination of each packet or to execute other processes. The processor 26 also processes packets that have security associations.

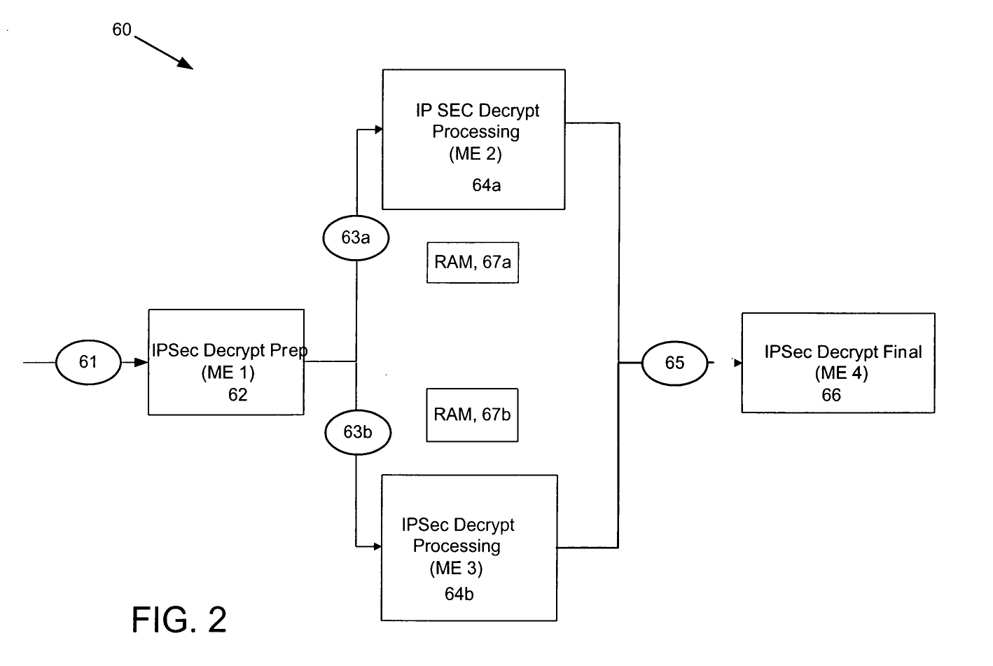

Referring to FIG. 2, an arrangement 60 for decrypting an IPSec packet is shown as distributed over three stages, namely an IPSec decryption preparation stage 62, an IPSec decryption stage 64, and an IPSec Decrypt final processing stage 66. Depending on throughput requirements (e.g., the number of IPSec packets processed per second), the code to perform these tasks is loaded into an appropriate number of microengines (ME1-ME4). In the following discussion the three stages are loaded among four microengines 22a-22f of the processor shown in FIG. 1. However, depending on the throughput requirements fewer or more of the microengines can be used.

In the arrangement, packet flow occurs from one micro engine to another. In FIG. 2 data flow for IPSec decryption processing is shown. The IPSec decryption preparation stage 62 uses, e.g., eight threads on a single microengine. Each thread handles one IPSec packet at a time. To maintain packet sequencing, the threads execute in order.

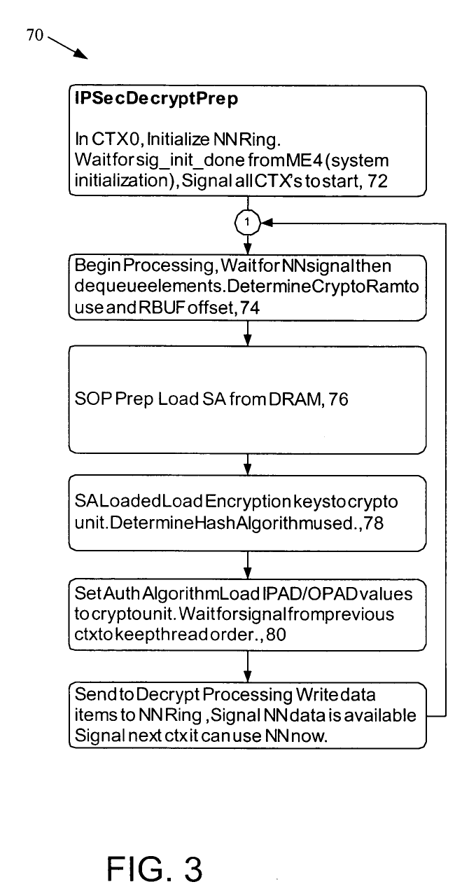

The IPSec decryption preparation stage 62 obtains information regarding a received IPSec packet through a Next Neighbor (NN) ring 61 once signaled that data exists. An IPSec decryption stage 64 (two of which 64a and 64b are shown in FIG. 3) and RAM 67a, 67b dedicated to the stages 64a and 64b respectively are loaded with decryption keys, and authentication keys if authentication is specified in a security association (SA) that is provided from an Security Policy Database (SPD) (not shown).

From IPSec decryption preparation stage 62, the packet information is passed on to the IPSec decryption stage 64 through the use of Next Neighbor rings 63a, 63b, respectively. Packets from the IPSec decryption preparation stage 62 go to either one of the IPSec decryption stage 64 of which two are illustrated, 64a, 64b executing on different microengines. The IPSec decrypt preparation stage 62 performs most of the processing before any cryptographic operations are done on the packet. Status information is communicated from “IPSec Decryption stage 64a and IPSec Decryption stage 64b back to the IPSec decryption preparation stage 62 to indicate when resources are free and available for subsequent packets, and so forth.

The IPSec decryption stage 64 uses, e.g., eight threads on a single microengine (e.g., one thread for management and seven for packet processing). Each thread handles one IPSec packet at a time. Context 0, retrieves packet data from the Next Neighbor ring, and stores it in queues in local memory. Contexts 1-7 pull the data from queues in the local memory and processes the packet data.

To maintain packet sequencing, the threads execute in order. The IPSec decryption stage 64 obtains information regarding an IPSec packet that has been prepared for inbound processing by the IPSec decryption preparation stage 62. The information is received through its Next Neighbor (NN) ring once signaled that data exists. The IPSec decryption stage 64 moves the packet from a receiver buffer (Rbuf pointer in the NN not shown) to a dedicated crypto RAM (RAM used by the crypto core to receive the packet data). The IPSec decryption stage 64 performs a cipher and hash operation on the IPSec packet to decrypt and authenticate the data. Once authenticated, decrypted data from the packet is written to a packet data buffer and eventually passed on to the IPSec decryption final stage 66 through the use of a next neighbor ring 65.

The IPSec Decrypt Final stage 66 uses eight threads on a single microengine, each of which handles a IPSec packet at a time. This block obtains information regarding the outcome of the processing of an inbound IPSec packet. Once the information is received, a successfully authenticated packet is validated against the Security Policy Database (SPD) for completeness. If successful this indicates that the original IP packet was properly sent. Once the SPD operation is completed the packet data buffer is released back to the system for further processing.

Referring to FIG. 3, the IPSec decrypt preparation stage 62 processing 70 performs operations required before any cryptographic operations are performed. These operations include specifying 72 the RAM address space for RAM 67a, 67b, loading of decryption keys, and performing IPad/OPad (preparing authentication keys for a hash) if necessary.

The decrypt preparation stage 62 waits for the next neighbor ring 61 to dequeue elements and determines 74 the RAM 67 to use and an RBUF offset. In one example, an element is seven long words of information regarding a received IPSec packet. The decrypt preparation stage 62 obtains the element through its Next Neighbor (NN) ring 61 once signaled that data exists. The decrypt preparation stage 62 loads 76 the SA from DRAM and once the SA is loaded, loads 78 encryption keys to the and determines a hashing algorithm to use. The SA index information received is used to read the SA material from the SA database in DRAM.

The decrypt preparation stage loads 80 IPAD/OPAD values and waits for a signal from a previous CTX (context) to keep thread order. The decrypt preparation stage sends to decryption processing by writing data items to the next neighbor ring 62a or 62b of the next microengine, and signals the next neighbor ring that data are available. The decrypt preparation stage 62 also signals the next context (CXT) that the next CXT can now use the next neighbor ring. The resource information (i.e. unit, bank, state) is used to determine the region of the RAM 67 that this packet has access too.

From the decrypt preparation stage 62, packet information is passed on to the IPSec Decryption stage 64 through a Next Neighbor ring, e.g., either ring 63a or 63b. Packet information are queued to the NN ring 63a or 63b, and the IPSec decryption stage 64 is signaled that it has data on its NN ring. Once this is done the thread signals the next thread that it may send data on the NN ring, keeping packet order.

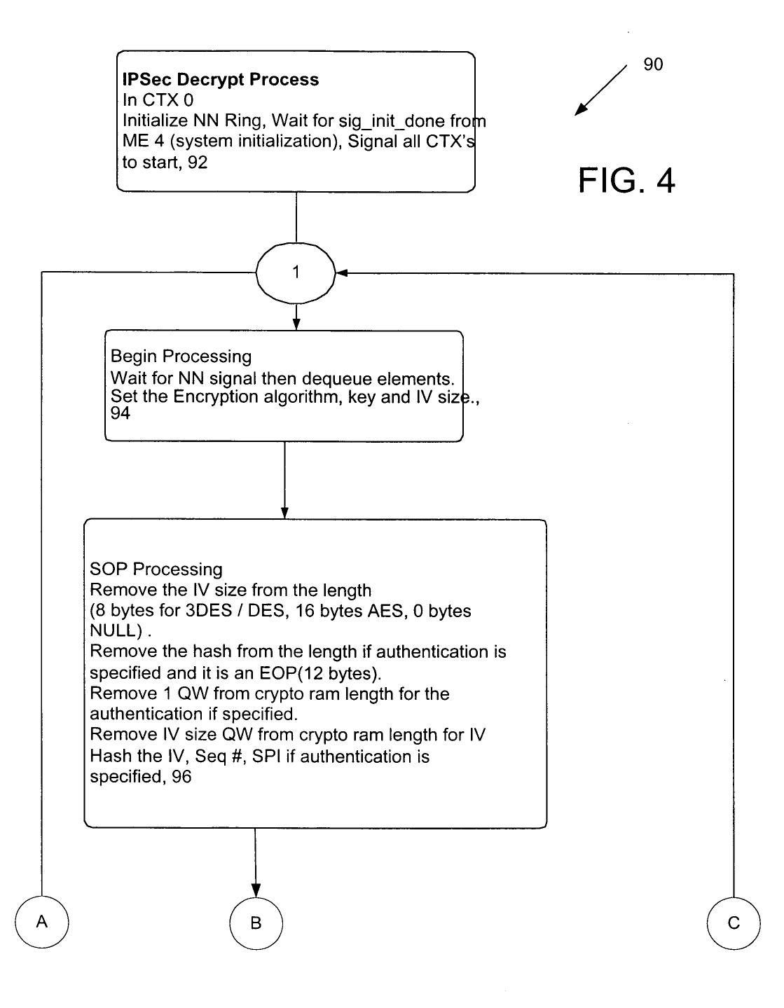

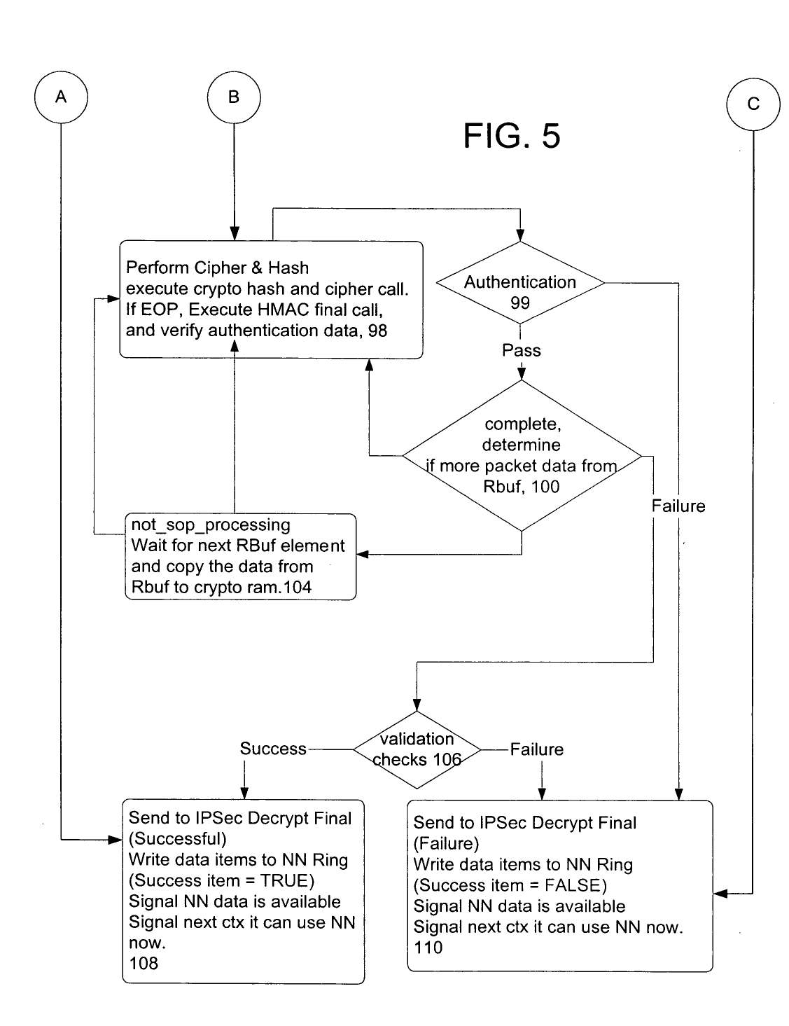

Referring to FIGS. 4 and 5, processing 90 on the IPSec decryption stage 64 retrieves 92 the packet information from the NN ring that was prepared for inbound processing by the preprocessing stage 62. The information is received through the Next Neighbor (NN) ring 63a or 63b once signaled that data exists. Once the information is received the cryptographic algorithm, key and IV size are determined from the SA information.

The IPSec decryption stage performs 94 the operations on the packet to decrypt the packet, moves the packet data from Rbuf to RAM 67a or 67b, specifying offsets into the packet, loading the initialization vector (IV), validating authentication data, and storing decrypted resulting packet into DRAM. Once the RBUF data is written to the RAM 67a or 67b the RBUF element can be released. Since SPI, Seq #, and IV values are accessed by the stage 64 these elements can reside on a 64-bit boundary. Therefore, the packet is written to the RAM 67a or 67b with an alignment to the left of 2 bytes for IPv4, and an alignment to the left of 6 bytes for IPv6.

The IPSec decryption stage 64a or 64b performs 92 an initialization in CTX 0 by initializing the NN Ring, and waiting for a “sig_init_done” from a microengine (system initialization), signaling all CTX's to start processing. The IPSec decryption stage 64 begins processing by waiting for NN signal and dequeues 94 elements from the NN ring. The process sets the Encryption algorithm, key and IV size.

The IPSec decryption stage 64a or 64b starts 96 packet processing (SOP) removes the IV size from the length, (8 bytes for 3DES/DES (Data Encryption Standard), 16 bytes AES (Advanced Encryption Standard), 0 bytes NULL, removes the hash from the length if authentication is specified and it is an end or packet (EOP) (12 bytes) and removes 1 quad word from RAM length for the authentication if specified. The process removes IV size a quad word from RAM 67a or 67b length for IV Hash the IV, Seq #, SPI if authentication is specified. The IPSec decryption stage 64 executes 98 crypto hash and cipher calls. If there is an endo f packet (EOP), the IPSec decryption stage executes a HMAC final call, and verifies 99 authentication data.

The IPSec decryption stage 64 determines 100 if there are more packet data from the current Rbuf element, waits 102 for next RBuf element and copies 104 the data from Rbuf to crypto RAM and performs the cipher and hash, otherwise the IPSec process performs validity checks 106 sending either a success or failure message to the IpSec final stage. If the authentication passed, the IPSEC process determines 108 if there are more packet data in the current Rbuf element. If there is an authentication failure, IPSec decryption stage 64 sends 110 to the IPSec Decrypt Final stage 66 a failure message by writing data to NN Ring, signal the NN that data is available and signals the next ctx it can use the NN.

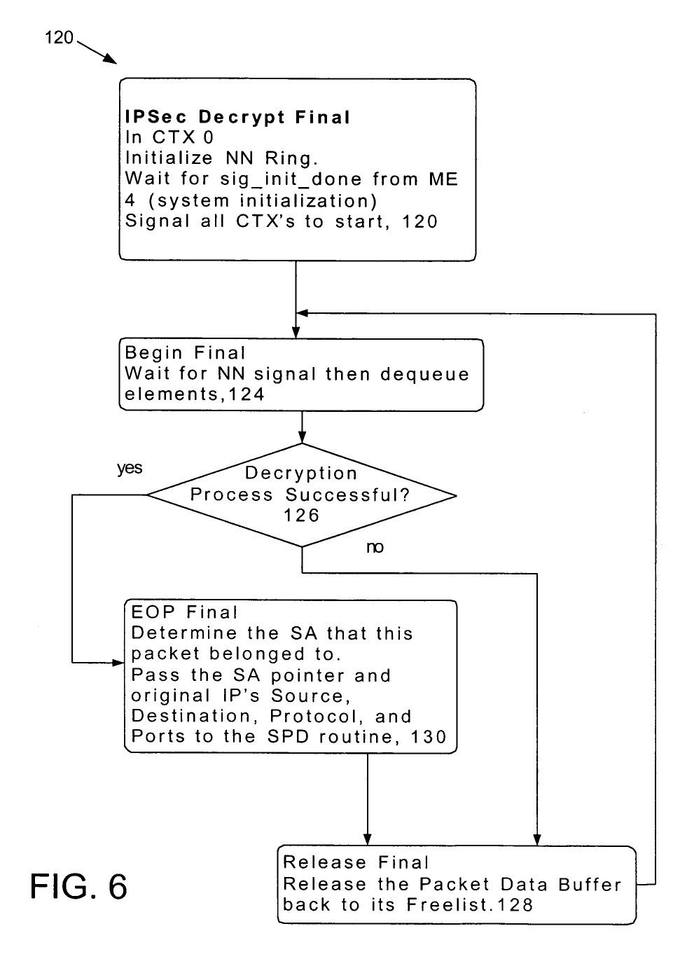

Referring to FIG. 6, the IPSec Decrypt Final stage 66 performs the work required after decryption of the packet, which includes a lookup to the security policy database (SPD), and updating counters. The IPSec Decrypt final stage obtains information regarding the outcome of the processing of an inbound IPSec packet. The information is received through its Next Neighbor (NN) ring once signaled that data exists.

Processing for IPSec Decrypt Final stage 66 includes initializing 122 the NN Ring and waiting for sig_init_done from the microengine and signaling all CTX's to start. The stage 66 begins final processing by waiting for NN signal then dequeue elements.

Once the information is received the success indication is checked 126 to determine if the IPSec inbound processing was successful or failed. Failure in the processing may be due to authentication failure, or any of the checks required in later processing. If failure is found, no further processing is done so the packet is dropped by releasing the packet buffer to the freelist.

If a successful indication is found then the IPSec packet was decrypted properly. The IP packet is validated 130 against the Security Policy Database (SPD) for completeness. If validation was successful, this indicates that the original IP packet was properly sent. Once the SPD operation is completed the packet data buffer is released back for further processing by other processes.

The arrangement in FIG. 3 could be modified to perform IPsec encryption processing, as will described below. In one implementation, an IPsec encryption prep stage and an IPSec Encrypt Processing stage are disposed over two microengines.

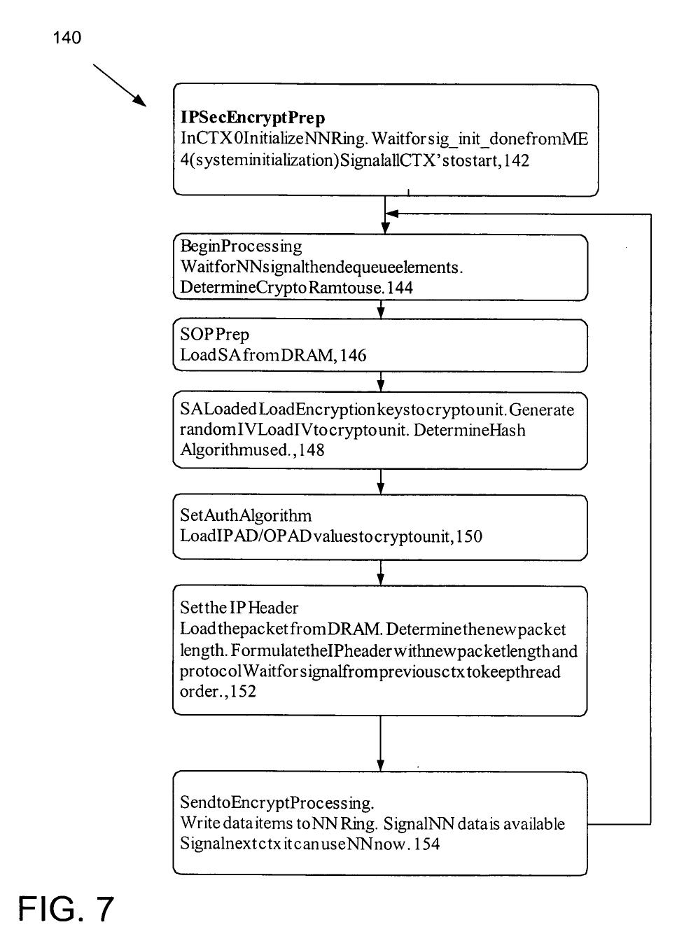

Referring to FIG. 7, IPSec encryption prep stage processing 140 performs the work required before any crypto operations are done on a packet. The process 140 includes an initialization, 142, specifying the RAM address space 144, loading 146 of SA from DRAM, loading 148 of encryption keys, generating of a random IV, and loading the generated IV to the crypto core. The IPSec encryption prep stage also performs IPad/Opad, if necessary, 150 and stores the IP header into the data packet buffer.

The IPSec encryption prep stage obtains 152 information regarding a received packet through its Next Neighbor (NN) ring once signaled that data exists. The SA index information received is used to read the SA material from the SADB in DRAM. The SA structure is required to encrypt the packet with the appropriate cipher and authentication. The resource information (i.e. unit, bank, state) is used to determine the region of the RAM 67a or 67b that the packet has access too.

The Encryption keys from the SA are loaded and the authentication algorithm is determined from the SA. A random IV is generated and loaded to the encryption stage (8 bytes for 3DES/DES, 16 bytes for AES, and 0 bytes for NULL). The IPAD and OPAD for authentication are also loaded to the encryption stage.

The packet is read from DRAM, and the packet length is extracted, to determine the length of the new packet. An IP header is formed with the new length and protocol, and is saved in DRAM in the in_pkt_outbuff_ptr.

From the IPSec encryption prep stage, the packet information is passed 154 on to the IPSec Encrypt Process Micro block through the Next Neighbor ring. In total 11 long words are queued to the NN ring, and the IPSec Decrypt Process is signaled that it has data on its NN ring. Once this is done the thread signals the next thread that it may send data on the NN ring, to maintain packet order.

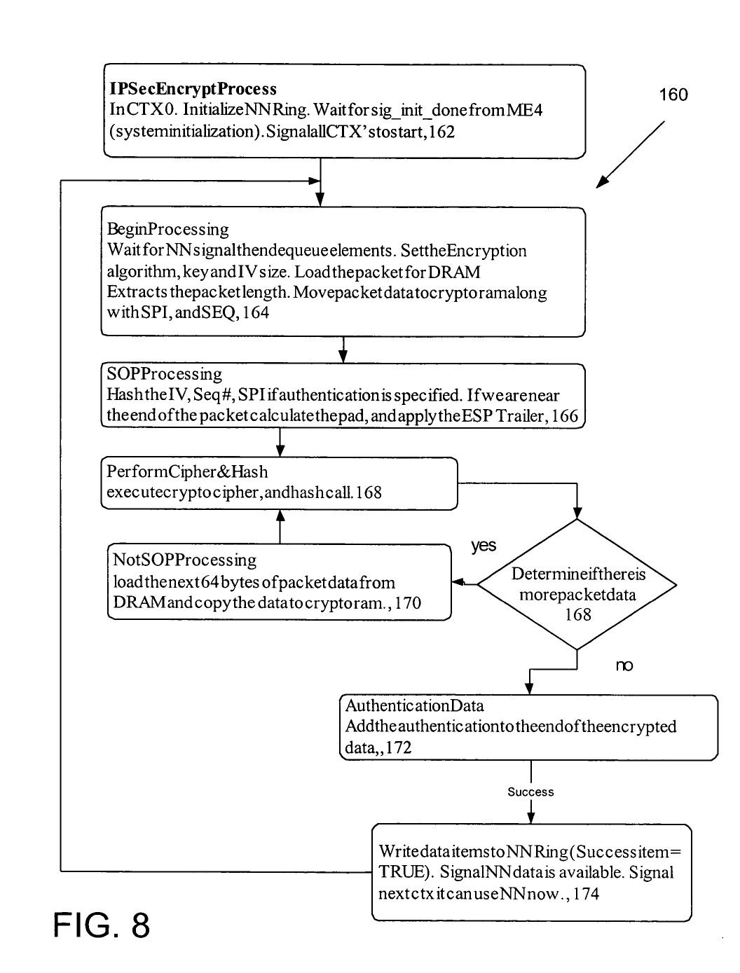

Referring to FIG. 8, an IPSec Encrypt Processing stage operates on the packet to encrypt the packet. The operations to encrypt the packet include moving the packet data from DRAM to crypto RAM, specifying the offsets into the packet, padding the data to a multiple of 8 for 3DES/DES or 16 for AES or 4 for NULL, generating authentication data, and storing encrypted resulting packet into DRAM.

The IPSec Encrypt Processing stage performs an initialization 162, obtains 164 information regarding a packet that has been prepared for outbound processing. The information is received through its Next Neighbor (NN) ring once signaled that data exists. Once the information is received the encryption algorithm, key and IV size are determined from the SA information.

The SPI, Sequence number, and the packet data are copied to RAM 67a or 67b allocated by the unit_bank_state. If authentication is specified, the SPI, sequence number and IV are hashed 166 separately as part of the authentication process.

The packet is processed with a cipher and hash crypto call 168. Once crypto and hash operations are complete, is written to the packet data buffer in DRAM.

A check is performed to determine if there is more packet data 170, and if so, the IPSec Encrypt Processing stage loads 170 the next block of 64 bytes from DRAM to crypto RAM, and continues the cipher and hash crypto calls until it reaches the end of the packet.

As IPSec Encrypt Processing stage approaches the end of the packet, or the last block, the IPSec Encrypt Processing stage determines any required padding and applies such padding as part of the IPsec header ESP trailer.

Processing packets that span more than 64 bytes requires additional processing. Data will be left from the first Rbuf element, i.e., the first 64 bytes processed, because when header information is considered, there are 50 bytes of data left to process which is not a multiple of 8 bytes. So the packet data from the next DRAM read are appended to the end, and the appropriate cryptographic operations are performed. If more data are left to process then the next DRAM read is copied to the beginning of the RAM 67 allocated for that unit_bank_state, and the appropriate cipher and hash crypto calls are made.

Once the end of the packet has been processed, the authentication 172 is appended to the end of the packet if authentication was specified. The IPSec Encrypt Processing stage uses, e.g., eight threads on a single microengine (e.g., one for management and seven for packet processing), each of which handles one IP packet at a time. Context 0, retrieves packet data from Next Neighbor, and queues it in local memory.

Contexts 1-7 pull the data from the queues in local memory, and processes the data. To maintain packet sequencing, the threads execute in order. From the IPSec Encrypt Processing stage 64, the packet information is passed 174 to a Next Neighbor ring to make results available to other processes.

A number of embodiments of the invention have been described. Nevertheless, it will be understood that various modifications may be made without departing from the spirit and scope of the invention. Accordingly, other embodiments are within the scope of the following claims.

1. An arrangement for processing a packet that has security associations, the arrangement comprises:
a preparation stage provided on a first microengine of a processor having plural microengines the preparation stage to prepare data used for processing the packet;
a processing stage provided on a second microengine of the processor, the processing stage to perform at least one cryptographic operation on the packet; and
a final stage provided on a third microengine of the processor to validate the packet in accordance with security associations.

2. The arrangement of claim 1 wherein depending on throughput requirements at least one of the stages is implemented as plural microengines.

3. The arrangement of claim 1 wherein the three stages are distributed among four microengines of the processor.

4. The arrangement of claim 1 wherein the processing stage to perform at least one cryptographic operation on the packet is implemented on two separate microengines.

5. The arrangement of claim 4 wherein the first and second processing stages are loaded into two different microengines of the processor.

6. The arrangement of claim 1 wherein the first and second processing stages loaded into the two different microengines of the processor and are disposed logically in parallel between the preparation stage and the final processing.

7. The arrangement of claim 1 wherein the arrangement encrypts a packet.

8. The arrangement of claim 1 wherein the arrangement decrypts a packet.

9. The arrangement of claim 1 wherein packet flow occurs from one microengine to another through a Next Neighbor ring once a destination microengine is signaled by a source microengine that data exists.

10. The arrangement of claim 10 wherein the packet is an IPSec packet.

11. The arrangement of claim 10 wherein the packet is a packet that includes security associations.

12. A method, comprises
preparing an IPSec packet for processing on a preparation stage provided on a first microengine of a processor having plural microengines;
performing at least one crypto operation on the IPSec packet on a second microengine of the processor; and
validating the IPSec packet in accordance with security associations on a third microengine of the processor

13. The method of claim 12 wherein at least one of the stages is implemented as plural microengines.

14. The method of claim 12 wherein cryptographic processing on the packet is implemented on two separate microengines.

15. The method of claim 12 wherein the packet is an IPSec packet.

16. The method of claim 12 wherein the packet is a packet that includes security associations.

17. A computer program product residing on a computer readable medium for processing a packet comprises instructions to cause at least one microengine on a processor having plural microengines to:
prepare an IPSec packet for processing by obtaining packet information for processing the packet;
pass packet information to a ring structure for use by a subsequent IPSec processing stage.

18. The computer program product of claim 17 wherein the packet is an IPSec packet.

19. A network forwarding device comprising:
at least one physical interface;
a framer;
a network processor having multiple processing engines arranged as:
a preparation stage provided on a first microengine of a processor having plural microengines the preparation stage to prepare the packet for processing;
a processing stage provided on a second microengine of the processor, the processing stage to perform at least one crypto operation on the packet; and
a final stage provided on a third microengine of the processor to perform validate the packet in accordance with security associations; and
a switch fabric.

20. The device of claim 19 wherein the packet is an IPSec packet.

21. The device of claim 19 wherein the interface is a media access controller device.

22. The device of claim 19 further comprising SDRAM storing the at least one secondary table.

23. The device of claim 19 further comprising SRAM storing the at least one primary table.
